(19) United States
(12) Patent Application Publication
(10) Pub. No.: US 2011/0016465 A1
(43) Pub. Date: Jan. 20, 2011

(54) SYSTEMS AND METHODS FOR SYNCHRONIZING USER AND MACHINE DATA DURING TRACKING OF PRODUCTS ON A USER COMPUTER

(75) Inventors: Matthew Robert SIEGEL, Portland, OR (US); Carl Donald MACDONALD, LaCenter, WA (US); Kenneth A. GENGLER, Portland, OR (US)

Correspondence Address: Reed Smith LLP, P.O. Box 488, Pittsburgh, PA, 15230, US

(73) Assignee: CBS INTERACTIVE, INC., County of New Castle, DE (US)

(21) Appl. No.: 12/503,736

(22) Filed: Jul. 15, 2009

(51) Int. Cl. G06F 9/445; G06F 9/44

(52) U.S. Cl. 717/178; 719/328

(57) ABSTRACT

Systems and methods for synchronizing a web application service on a server with a user computer so that users are not required to log-in to access their data are described. An installed product application programming interface (IPAPI) is provided on the web server that is configured to associate a user ID associated with the user of the user computer with a machine ID associated with the user computer. The credentials are automatically transmitted to the web application through cookies from a browser at the user computer to the web application so the user does not have to log-in to the web application service or at their computer.

### BACKGROUND

1. Field

The subject invention relates to systems and methods for synchronizing user and machine data during tracking of products on user computers.

2. Related Art

Typically, when users purchase a new computer, the computer includes various software applications installed on their computer. Users also sometimes install other software applications. New versions of software applications are released by software companies periodically. Many computer owners that have these software applications on their computer are unaware of the releases of the new versions. In addition, users may be unaware of other software applications that would be beneficial to them.

In order to keep their software applications current, some computer owners download tools to track their current software applications and check for new versions of those software applications. One exemplary tool, CNET's Version Tracker, downloads a client to the user's computer which tracks the user's software applications. Users can access their tracking report at an accompanying website. The tracking report provides alerts if new versions are available for software applications on the user's computer and sometimes provides links to web pages that will allow the user to download the new version.

In order to access their tracking report, users are required to log-in to both the tool on their computer and the web page using their web browser so that their scans can be transmitted from their computer to the web page and the user can access their tracking report. Users are required to be logged in to both the tool and the web page at the same time.

If a user changes the password at either the tool or the web page, synchronization errors may occur. These synchronization errors can make it more difficult for the computer owners to download the new versions of the software applications. For example, the tool may not be able to communicate with the web page correctly or the web site may not be able to generate the tracking report for the user.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a method is provided that includes receiving product data at an installed product application programming interface, the product data associated with a machine identifier; receiving a user request to access a web application, the user request comprising the machine identifier and a user identifier; associating the machine identifier at the installed product application programming interface (IPAPI) with the machine identifier from the user request and mapping that machine identifier at the IPAPI to the user identifier; generating a web page that includes a tracking report using the product data; and delivering the web page to the user.

The product data may be matching product data. The product data may be scan data.

The user identifier may be associated with a plurality of machine identifiers. The method may also include matching the scan data associated with each of the plurality of machine identifiers and allowing a user to download software so that each machine has the same installed software.

The web page may provide access to a catalogue.

The product data may include data about software applications installed on the user computer. The product data may include data about data files stored on a user computer.

The installed product application programming interface may receive the product data periodically.

According to another aspect of the invention, a computer-readable storage media is provided having computer executable instructions stored thereon which cause a computer system to carry out a method when executed, the method including receiving product data at an installed product application programming interface, the product data associated with a machine identifier; receiving a user request to access a web application, the user request comprising the machine identifier and a user identifier; associating the user identifier with the product data at the installed product application programming interface by matching the machine identifier at the installed product application programming interface with the machine identifier in the user request; generating a web page that includes a tracking report using the product data; and delivering the web page to the user.

According to a further aspect of the invention, a computer system is provided that includes a processing module configured to receive a user request to access a web page, the user request comprising a user identifier and a machine identifier, the machine identifier associated with a user computer and the user identifier associated with a user of the user computer, the processing module further configured to deliver a web page to the user responsive to the user request; and an installed program application programming interface in communication with the processing module and configured to receive a machine identifier and product data from the user computer, the installed program application programming interface further configured to receive the machine identifier and the user identifier from the processing module and associate the product data with the user identifier by matching the machine identifier from the processing module with the machine identifier stored at the installed program application programming interface.

The computer system may also include memory coupled to the installed program application programming interface and configured to store the product data and the machine identifier.

The user request may store information in a cookie and the processing module may be configured to extract the user identifier and machine identifier from the cookie.

The computer system may also include a catalogue in communication with the processing module, the processing module configured to allow users to access the catalogue.

The computer system may also include a client adapter coupled to the web application, the client adapter configured to match scan data from a scan of the user computer to a copy of the catalogue stored to generate the product data received at the installed program application programming interface.

The computer system may also include a client downloadable to the user computer and configured to be in communication with the computer system, the client configured to transmit scan data from a scan of the user computer to the client adapter through the web application.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of a network system according to one embodiment of the invention;

FIG. 2 is a block diagram illustrating a server and a user system in further detail according to one embodiment of the invention;

FIG. 3 is a sequence diagram of a client application service according to one embodiment of the invention;

FIG. 4 is a sequence diagram of a matching service according to one embodiment of the invention;

FIG. 5 is a sequence diagram of a web application service according to one embodiment of the invention;

FIG. 6 is a flow diagram of a process for tracking software on a user's computer according to one embodiment of the invention;

FIGS. 7A-7D are schematic diagrams of user interfaces for downloading the client according to one embodiment of the invention;

FIGS. 8A-8C are schematic diagrams of a user interface illustrating software for which updates are available according to one embodiment of the invention;

FIG. 9 is a schematic diagram of a user interface illustrating a future scan according to one embodiment of the invention; and

FIG. 10 is a block diagram of an exemplary computer system according to one embodiment of the invention.

### DETAILED DESCRIPTION

Embodiments of the invention relate to web-based tools for tracking installed applications or files on a user computer. In particular, embodiments of the invention synchronize a web application service on a server with a user computer so that users are not required to log-in to access their data. An installed product application programming interface (IPAPI) is provided on the web server that is configured to associate a user ID associated with the user of the user computer with a machine ID associated with the user computer. Once the IPAPI associates the user ID with the machine ID, the web application service can generate a web page for the user that identifies the applications or files on the user's computer and identifies whether new versions are available for the user (a tracking report) without the user logging in to the web application. In future requests to access their tracking report at the web application, the credentials are automatically transmitted to the web application through cookies from a browser at the user computer to the web application. When the web application queries the IPAPI, these credentials are delivered so that the IPAPI can access the user's data without the user logging-in either at their computer or at the web application.

These systems and methods create a better user experience. A user only logs-in once (e.g., at the web application service during their initialization) to access their tracked data. In addition, because the user only logs-in once, credential synchronization issues are eliminated. These systems and methods can also be used to synchronize multiple user computers for a user (e.g., a personal computer and a work computer can be synchronized using the web application).

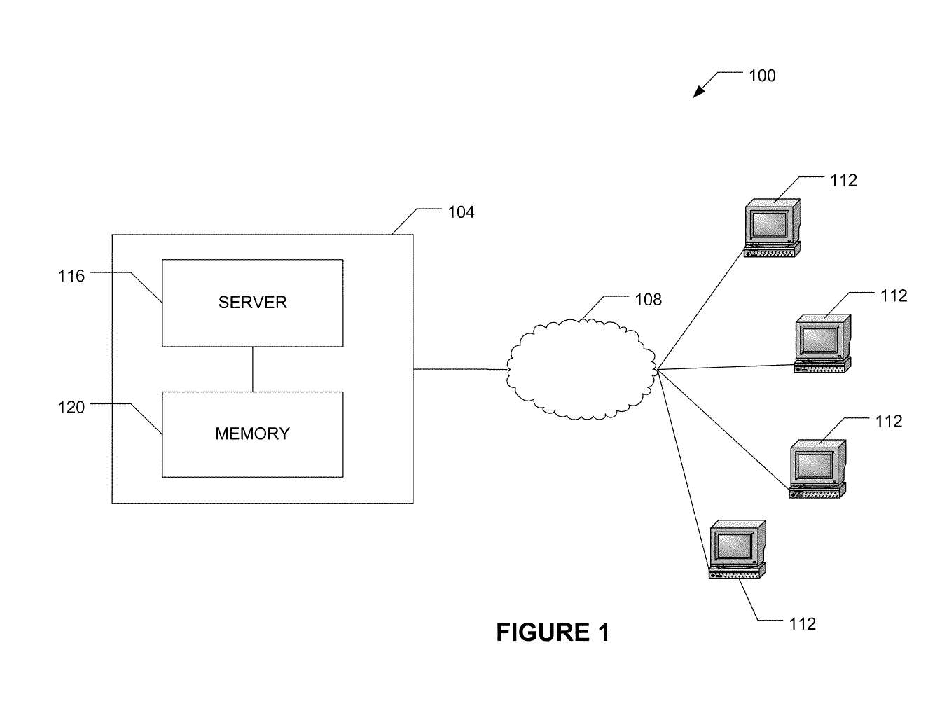

An embodiment of the invention will now be described in detail with reference to FIG. 1. FIG. 1 illustrates a web-based system 100 for tracking files on a user's computer and synchronizing user credentials at a web application and a user computer. The system 100 includes a tracking system 104 and a plurality of user systems 112 coupled via a network 108. The system 104 includes a server 116 and memory 120.

The tracking system 104 is connected to the plurality of user systems 112 over the network 108. The server 116 is in communication with the memory 120. The system 104 is typically a computer system, and may be an HTTP (Hypertext Transfer Protocol) server (e.g., an Apache server). The memory 120 includes storage media, which may be volatile or non-volatile memory that includes, for example, read only memory (ROM), random access memory (RAM), magnetic disk storage media, optical storage media, flash memory devices and zip drives.

The network 108 is a local area network (LAN), wide area network (WAN), a telephone network, such as the Public Switched Telephone Network (PSTN), an intranet, the Internet, or combinations thereof.

The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers.

When a user of one of the plurality of user systems 112 requests to access the server to view their tracking report, a request is communicated to the system 104 over the network 108. For example, a signal is transmitted from one of the user systems 112, the signal having a destination address (e.g., address representing a web application associated with the tracking system), a request (e.g., a request to view the user's tracking report) and a return address (e.g., address representing user system that initiated the request). The request may include a cookie that includes data identifying the user and/or the user computer. The server 116 accesses the database 120 to provide the user with a list of files on their computer and versions for which the user needs updates, which is communicated to the user over the network 108. For example, another signal may be transmitted that includes a destination address corresponding to the return address of the client system, and a list responsive to the request.

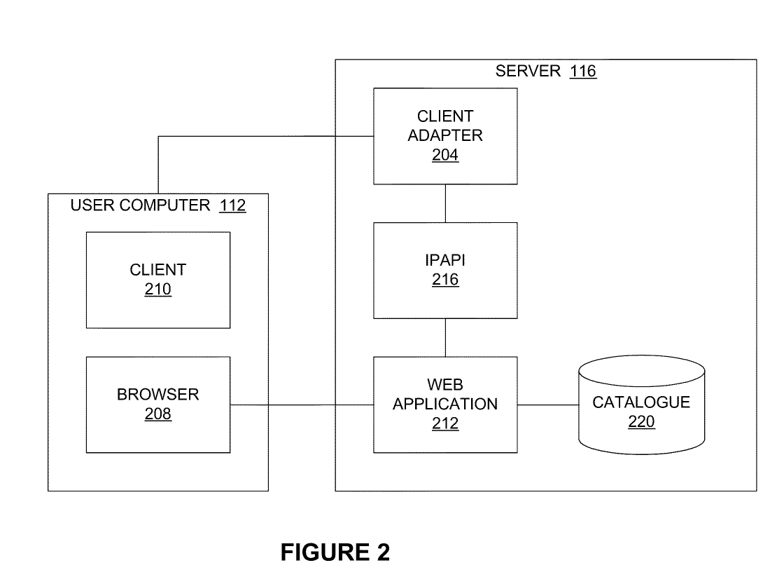

FIG. 2 illustrates the server 116 and user computer 112 in further detail. As shown in FIG. 2, the user computer 112 includes a browser 208 and a client 210, and the server 104 includes a client adapter 204, a web application 212, an installed product application programming interface (IPAPI) 216 and a catalogue 220. The catalogue 220 may be stored in the memory 120. An installed products database (not shown) may also be provided in the memory 120, the installed products database in communication with the IPAPI 216.

The browser 208 is used to access the web application 212 from the user computer 112. A user logs-in to the web application 212 at the browser 208, which communicates the request to access the web application 212 together with user information and machine information. Users access their tracking report using the browser 208. Users can also download new versions of software or new software applications using the browser 208 (e.g., by selecting links in the tracking report).

The client 210 is configured to scan the user computer 112 to identify the software on the user's computer. The client 210 is configured to scan the user computer 112 periodically. In one embodiment, the client 210 receives a scan identifier (scan ID) each time from the client adapter 204 before performing a scan of the user computer. The scan data includes information about the software applications installed on the user computer that can be used to determine whether the version on the user computer is current. Exemplary data that the client 210 may identify in the scan for a software application scan is provided in Table 1.

TABLE 1
Exemplary Application Information

| Tags or Attributes | Descriptions |
|---|---|
| Sequence | The sequence number of the item. It starts with 1. |
| ProcessIdentity | ProcessIdentity has the following tags |
| BaseName | The exe file name |
| CheckSum | The CheckSum of the exe file image |
| CheckSum | The MD5 checksum digest. It is an 128 bits digest of an exe |
| algorithm=”MD5” | image. It's converted to 32 chars. For example: |
| | 1818f4472aadda8f10ac7627139eacec |
| PathName | The absolute path of the exe file |
| Version | The “From” attributes of the tag has the following values: |
| | FileVersion_FIXEDFILEINFO |
| | ProductVersion_FIXEDFILEINFO |
| | FileVersion_String |
| | ProductVersion_String |
| Name | The “From” attributes of the tag has the following values: |
| | ProductName_String |
| | FileDescription_String |
| ProgName | The program name of the exe |
| PackageName | The package name |
| InstalledVers | InstalledVers is the ProductVersion of the image. If it's null, |
| | it uses InstalledVers2. |
| InstalledVers2 | InstalledVers2 is the FileVersion of the image |
| InstalledVers3 | InstalledVers3 is constructed from FixedFileInfo structure, |
| | using dwFileVersionMS and dwFileVersionLS DWORD |
| | members. |
| ExecutableName | The exe name |
| TargetName | The absolute path of the exe file |
| IsDriver | Boolean value: true or false |
| ItemType | ItemType has the following possible values: |
| | “comFromReg”: component is found from the |
| | registry |
| | “driver”: driver item |
| | “exe” or empty: normal executable item |
| | “suite”: suite item |
| Md5Id | Md5Id is the unique identification of the item. Exe item and |
| | suite item should have this tag. |
| | Exe Md5Id: It's the md5 checksum of the entire |
| | executable file. |
| | Suite Md5Id: It's the md5 string digest of the suite |
| | product GUID and suite installed version string. |
| GUID | For example, the GUID may be a 38 char string, 39 bytes |
| | with null (a string representation of a GUID): |
| | {AE314E8E-2514-4F04-8496-F90F65B382DF} |
| | It has the following attributes: |
| Product | The product GUID |
| Component | The component GUID |
| Icon | Icon tag appears if the server requests it. It has the following |
| | attributes |
| productID | The product Id which needs the icon |
| Width | Width of the icon. It has a value of 32 or 16 |
| Height | Height of the icon. It has a value of 32 or 16 |
| pixelDepth | The number of bits for a pixel in the image, for example 32. |
| hasAlpha | Boolean value if the image has a alpha channel |
| Format | Image format. For example, it may support “PNG”. |
| Encoding | Data encoding. For example, it may support “Base64” with |
| | ATL_BASE64_FLAG_NOCRLF flag. |

It will be appreciated that the client 210 may scan the computer to locate only portion of the items identified above, different items then those described above, or more items than those described above. After the client 210 scans the user computer 112, the client 210 contacts the client adapter 204 and provides the scan data and machine identifier. In one embodiment, the client 210 is downloadable from the server 104 to the user computer 112.

The client adapter 204 includes a copy of the catalogue 220 and is configured to periodically query the catalogue 220 to check for updates to the catalogue 220. The client adapter 204 compares the scan data to the copy of the catalogue 220 at the client adapter 204. For example, if a software application has GUID, the client adapter 204 uses the component GUID to find a match in the catalogue. If the client adapter 204 does not find a GUID during the scan, the client adapter uses the exe information (e.g., one or more of the MD5ID, executable name, version data, Checksum, etc.) to query the catalogue 220. The client adapter 204 generates a matching product file that identifies the installed products and version information for those installed products. It will be appreciated that other matching processes may be used to identify whether a user needs new products on their computer.

The client adapter 204 then delivers the matching product file to the IPAPI 216. For example, the client adapter 204 may build the outgoing data in an xml format.

The client adapter 204 also delivers the matching product file to the client 210. The client adapter 204 may also deliver the outgoing data in, for example, an xml format to the client 210.

The web application 212 is in communication with the web browser 208 so that user's can access their tracking report. When a user first accesses the web application 212 through the browser 208, a cookie is generated and transmitted to the web browser 208. The cookie includes data about the user such as a user identifier that uniquely identifiers the user, a machine identifier that uniquely identifies the user computer and, optionally, a scan identifier.

The web application 212 is also configured to query the IPAPI 216 to identify the products installed on the user computer 112, and generate a tracking report using this data that can be delivered to the user as a web page. When the web application 212 queries the IPAPI 216, the web application 212 provides the user information from the cookie (e.g., the user identifier). The web application 212 is also in communication with the catalogue 220 and allows users to download new versions of the software from the catalogue 220 or new software applications from the catalogue 220.

The IPAPI 216 is in communication with the client adapter 204 and stores and receives product data and a machine identifier from the client adapter 204 (e.g., in memory/database (not shown) coupled to the IPAPI 216). The web application 216 queries the IPAPI 216 to access the product data. The web application query includes the user ID, machine ID and, optionally, the scan ID. The IPAPI 216 is configured to associate the machine ID with the user ID so that the product data provided by the client adapter 204 to the IPAPI 216 can be associated with the user ID. The IPAPI 216 can then deliver the product data back to the web application 212. Because the web application 112 can extract the user information from the cookie and the IPAPI 216 can associate the user information with the product data, users are not required to log-in at the web application or at their computer to access their tracking report.

The catalogue 220 includes software applications and information about the software applications. For example, the catalogue 220 may include the same or similar information as the information accessed during the scan conducted by the client adapter 204 (e.g., the same information provided in Table 1). The catalogue 220 also includes the latest version of the software applications themselves or links to the latest version of the software applications so that users can download the latest version of the software applications when the user accesses their tracking report.

In use, a user logs-in to the web application 212. In one embodiment, a user may need to download the client 210 from the server 104. The client 210 then conducts an initial scan of the user computer 112 to identify the software applications on the user computer 112. The client adapter 204 requests a machine ID during the initial scan and passes it to the client 210 that is associated with the user computer 112.

When the client 210 performs a scan, the client 210 identifies data that identifies the software applications on the user computer 112 (e.g., the data described above with reference to Table 1). The scan data includes the MD5 signature of the executable, the executable name, the signature from the registry and registry entries.

The client 210 sends the scan data to the client adapter 204 which then matches the scan data with the catalogue data. The matching may be a multi-level matching algorithm. For example, a unique signature for the software application, a checksum of the executable and a checksum in the registry for the software application may be used to match the scan data to the catalogue data. GUIDs may also be attached in the registry to identify the software applications and identify matches. The client adapter 204 may also match the executable name or an aggregate of the company name, name and the like. If the client adapter identifies a match of the executable name but there is not a signature match, the client adapter 204 determines that the user needs a new version of the software. It will be appreciated that other methods can be used to identify new products needed by the user.

The client adapter 204 then sends matching product data to the IPAPI 216 after each scan. The client adapter 204 may also assign a scan ID to each scan. In these embodiments, the IPAPI 216 can store the product data along with the machine ID and scan ID. In other embodiments, the IPAPI 216 may store the product data with only the machine ID. In one embodiment, the matching product data is an XML formatted file.

When the user launches the browser 208 to access the web application 212 to access their tracking report, the browser 208 transmits a request to the web application 212 that includes the machine ID, user ID and scan ID (which may be in the cookie). The web application 212 queries the IPAPI 216 with the machine ID, user ID and scan ID and a request for the matching product data. The IPAPI 216 then associates the machine ID and user ID from the request to the machine ID and matching product data accessible by the IPAPI 216. The IPAPI 216 then delivers the matching product file back to the web application 212.

The web application 212 generates a tracking report using the matching product data from the IPAPI 216. The web application 212 also generates a web page that includes the tracking report and links to the software applications for which the user needs new versions in the catalogue 220. The web page may also include links to other content associated with the web site that hosts the web application 212, links to software applications that may be useful to the user, etc. The web application 212 then delivers the web page to the user at the browser 208.

The users can interact with the tracking report using their browser 208 and may choose to download the latest version of the software applications that the user needs through the catalogue 220. The user may download the software application directly from the catalogue 220 or the user may be linked to a web page or a web site where the user can download the latest version of the application.

It will also be appreciated that the above systems and methods can be used to track the software on multiple computers for a particular user. For example, each user may be associated with multiple machine identifiers (a machine identifier for each computer). Each machine identifier may be associated with different product data at the IPAPI 216 so that the user can access data about each of their computers through the web application. When the IPAPI 216 receives the user identifier from the web application 212, the IPAPI 216 can deliver all of the product data that corresponding to each machine identifier associated with that user identifier. Users can use this data to download software applications (or other files) so that each computer has the same software applications. For example, users who have both work computers and personal computers can access the web application 212 to easily set up both computers to have the same software applications (and/or other files).

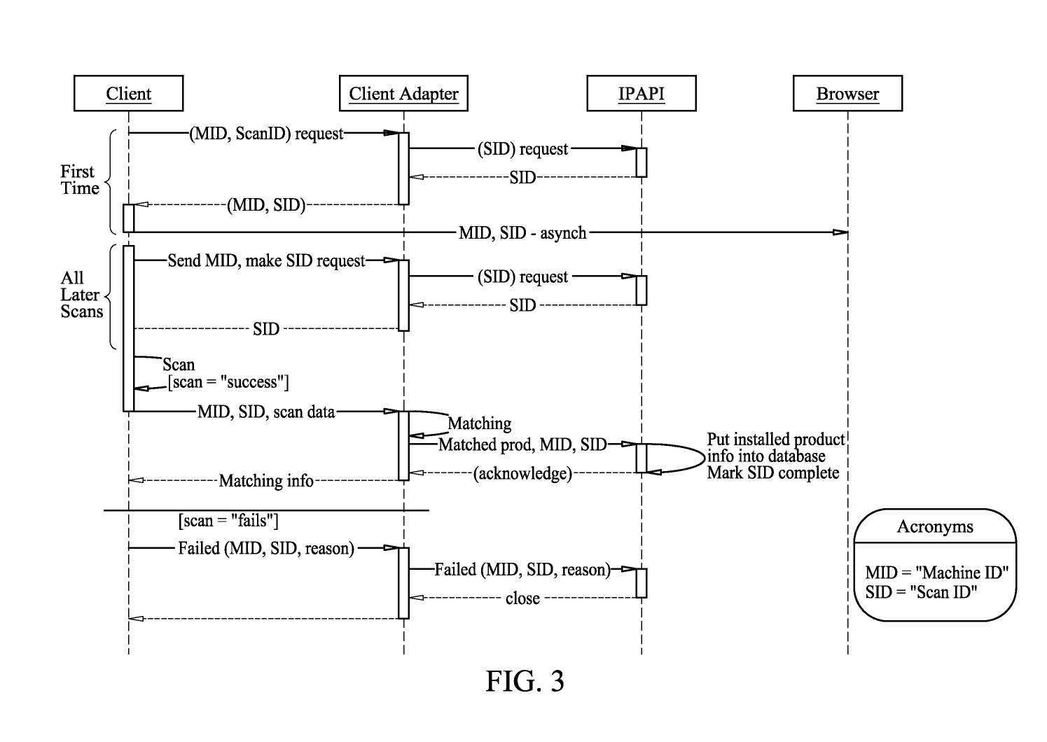

FIG. 3 illustrates an exemplary data flow sequence during installation and registration of the client on the user computer. As shown in FIG. 3, the first time a user logs into the system, a request that includes a machine ID and a scan ID is sent from the client adapter 204 to the client 210. The client adapter 204 sends a scan ID request to the IPAPI 216. The IPAPI 216 transmits a scan ID back to the client adapter 204 and the client adapter 204 generates a machine ID and returns the scan ID for the client 112. For later scans, the client 210 sends a machine ID and a scan ID request to the client adapter 204, and the client adapter 204 sends a scan ID request to the IPAPI 216, which returns a scan ID to the client adapter 204. The client adapter 204 sends the scan ID to the client 210 and performs a scan of the client 210 which returns the machine ID, the scan ID and the scan data to the client adapter 204.

The client adapter 204 then performs a matching algorithm to generate a matched product data file. The client adapter 204 transmits the matched product data file, the machine ID and the scan ID to the IPAPI 216. The IPAPI 216 stores the installed product data in memory (e.g., a database in memory with the machine ID and the scan ID) and marks the scan ID complete. An acknowledge signal may be transmitted to the client adapter 204 which sends matching information to the client 210 (e.g., an alert that the matching results are accessible via the tracking report). If a scan fails, the machine ID, the scan ID and the reason may be delivered to the client adapter which transmits the data to the IPAPI 216.

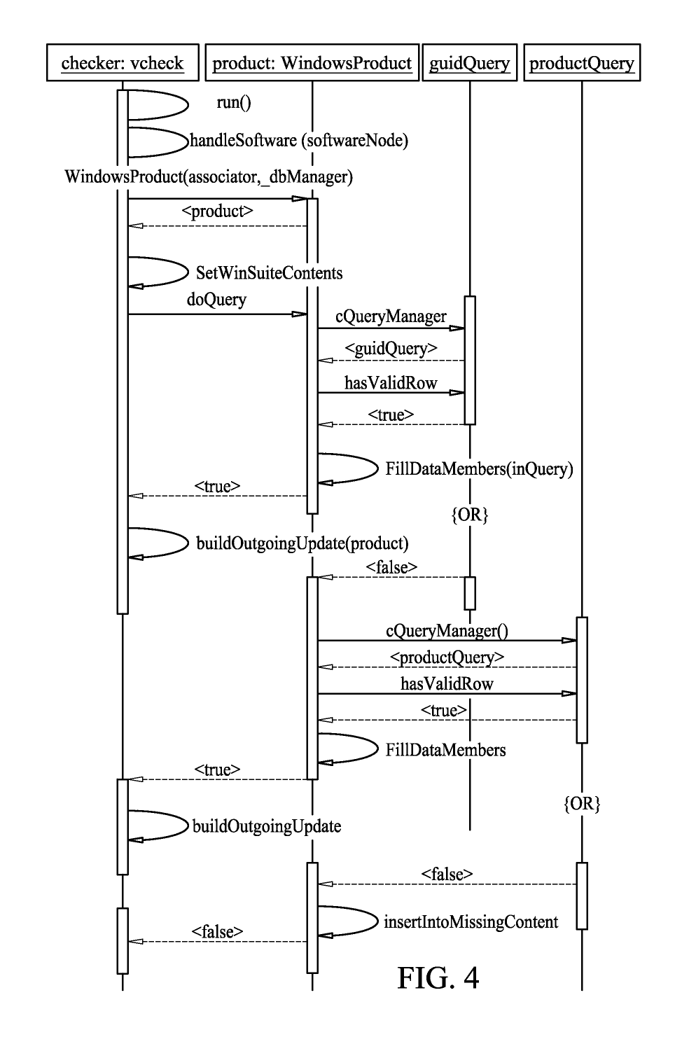

FIG. 4 illustrates an exemplary sequence of data flow during matching. As shown in FIG. 4, the server receives a check for updates requests, and creates a checker object and invokes a run method. The checker gets a proper xml node and calls the handleSoftware method. The checker finds out if the product is a windows item and creates a window product called product. The checker then invokes SetWinSuiteContents, and sets all the necessary suite product information to the product object. The checker then invokes a doQuery method. The product object creates a guidQuery object, and performs a sql call. The product checks if there is a valid row in the sql result. If there is a valid row in the sql result, the checker gets the row information and stores it in the product's data members. If the guid sql database call is successful, the checker builds the outgoing updates information based on the data in the product data members. If the guid query attempt fails, the checker creates a productQuery object for exe matching. The checker checks and sees if it has valid rows using the exe data. If the exe matching is successful, the checker builds the outgoing updates. If both guid and exe matching fail, the product objects inserts the item to the missing content table and returns false.

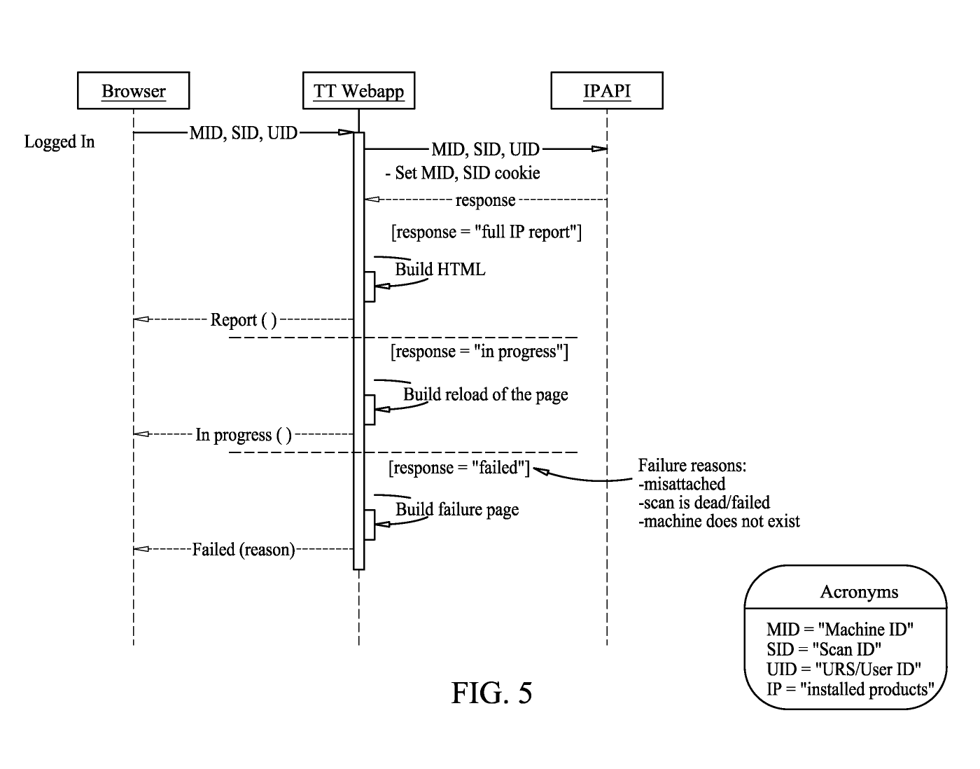

FIG. 5 illustrates an exemplary sequence of data flow at the server 116. As shown in FIG. 5, when a user is logged into the web application 212, the browser 208 transmits the machine ID, scan ID and user ID to the web application 212, which transmits the machine ID, scan ID and user ID to the IPAPI 216. It will be appreciated that the IPAPI 216 can then associate the user ID and machine ID with the stored machine ID and matching product data. The web application 212 may also set the machine ID cookie. A response is sent from the IPAPI 216 to the web application 212, which builds a web page using the matching product data. The web page with the tracking report is then delivered to the browser 208. It will be appreciated that the web application 212 may build a reload of the web page or the web page build may fail.

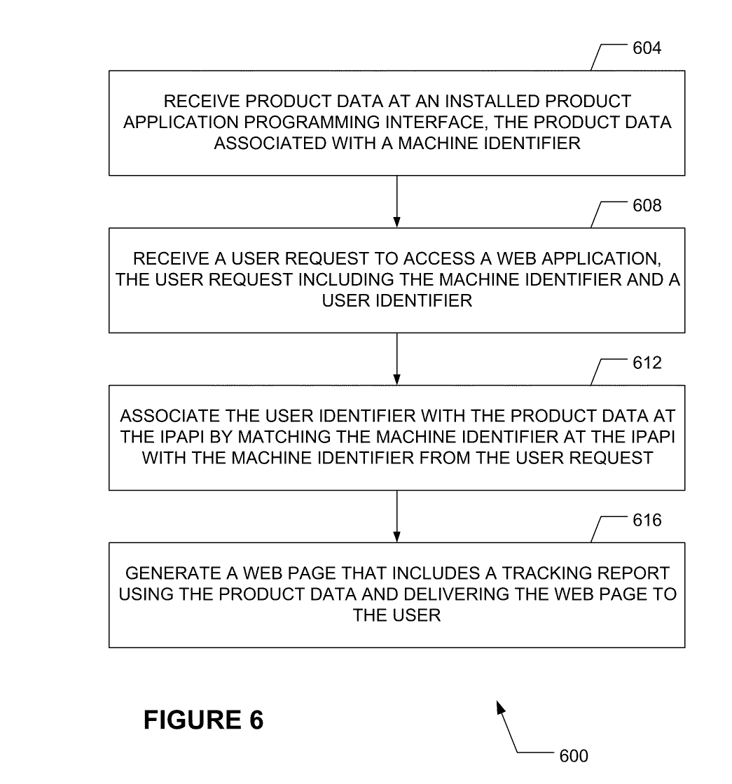

FIG. 6 illustrates a process 600 for associating a user with a machine and generation and delivery of a tracking report to the user. It will be appreciated that the process 600 described below is merely exemplary and may include a fewer or greater number of steps, and that the order of at least some of the steps may vary from that described below.

As shown in FIG. 6, the process 600 begins by receiving product data at an installed product application programming interface (IPAPI), the product data associated with a machine identifier (block 604). It will be appreciated that the IPAPI may receive the product data and the machine identifier periodically. For example, the IPAPI may receive the product data daily, every other day, weekly, monthly, and the like or in response to a manual request to perform a scan and match.

The process 600 continues by receiving a user request to access a web application, the user request comprising the machine identifier and a user identifier (block 608). In one embodiment, the machine identifier and the user identifier are delivered in a cookie from the browser to the web application.

The process 600 continues by associating the user identifier with the product data at the IPAPI by matching the machine identifier at the IPAPI with the machine identifier from the user request (block 612). In one embodiment, the web application 212 queries the IPAPI 216 for the product data, the query including the machine identifier and the user identifier from the user request. The IPAPI 216 may perform the association and then access the product data associated with the machine identifier from memory coupled to the IPAPI 216 and deliver the product data back to the web application 212 in response to the request.

The process 600 continues by generating and delivering a web page that includes the tracking report to the user using the product data (block 616). The tracking report identifies the software applications installed on the user computer and whether the user needs newer versions of the software applications. The web page may also include links to downloadable versions of the software application or other links that may interest the user. As described above, the process 600 may be used to track files other than software applications such as data files, drivers, and the like.

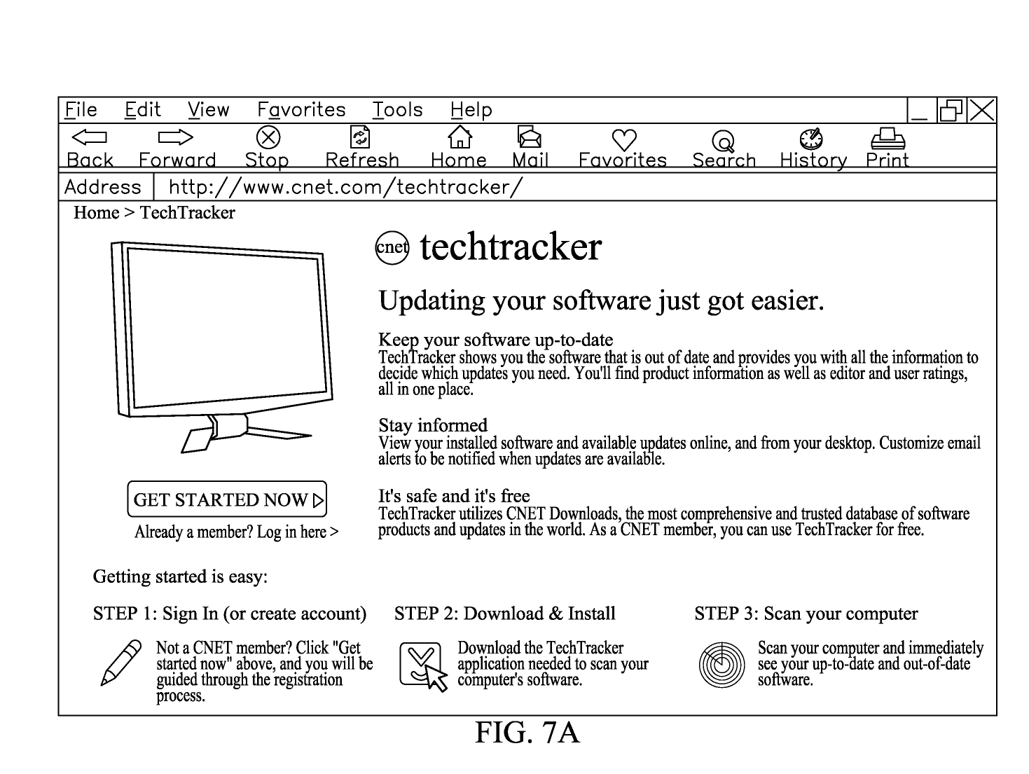

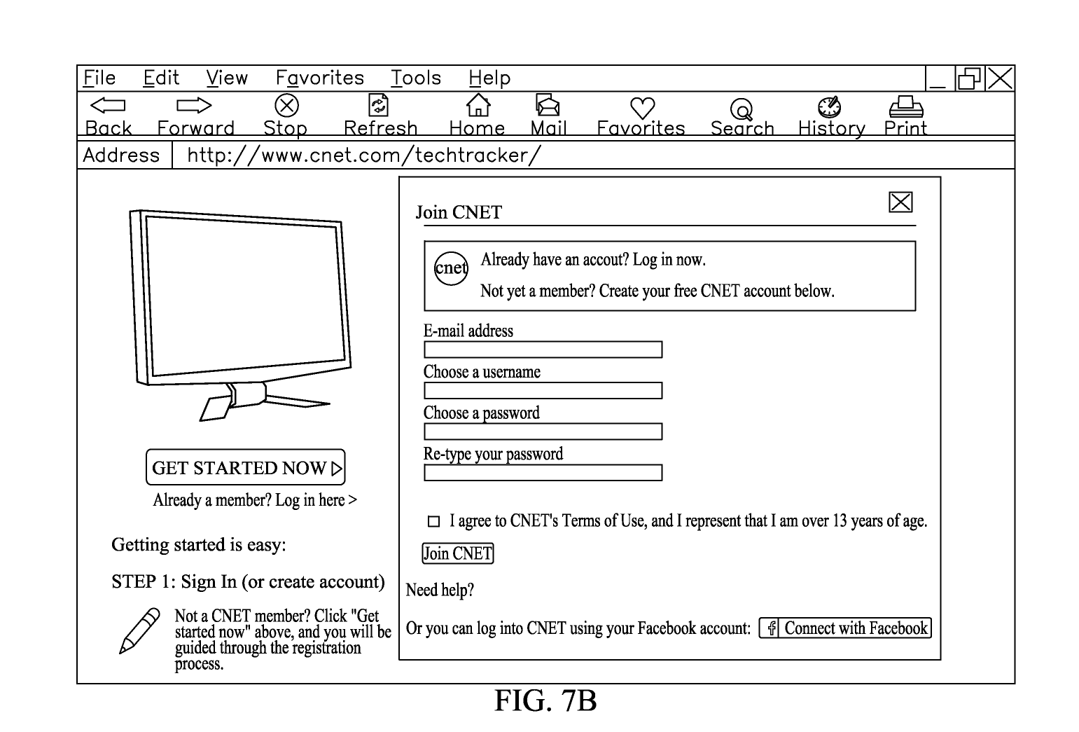

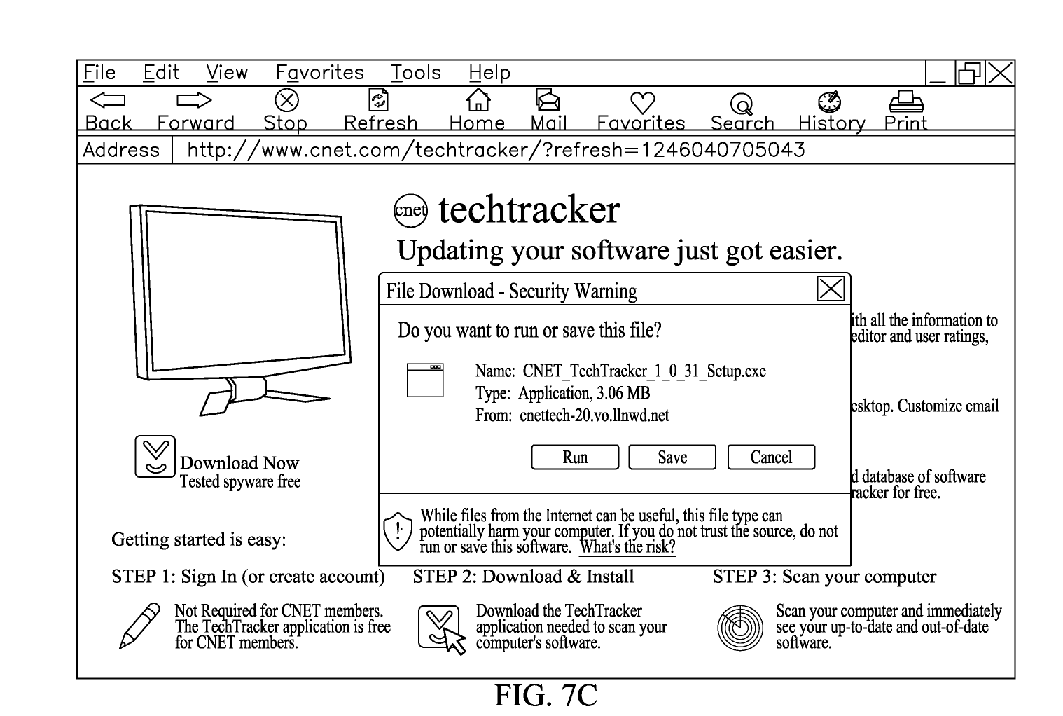

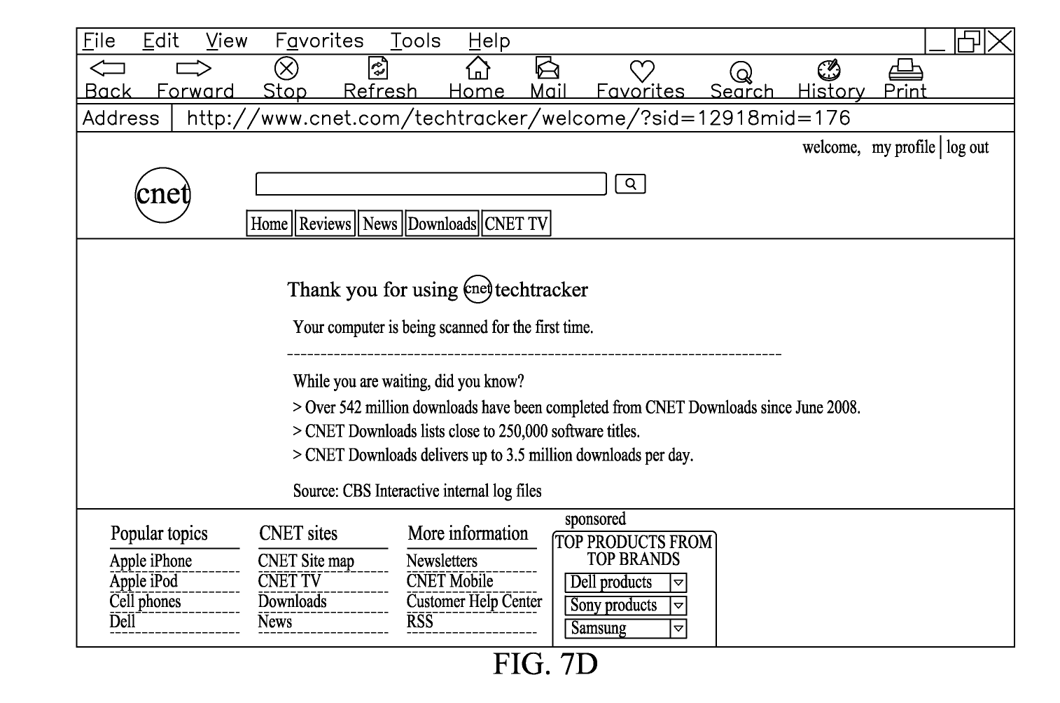

FIGS. 7A-7D illustrate exemplary user interfaces for downloading a scanning tool to the user computer. As shown in FIG. 7A, users keep their software up-to-date by signing in, downloading the application and then scanning their computer. FIG. 7B illustrates a screen for signing in. FIG. 7C illustrates a screen for downloading the client adapter to the user's computer. FIG. 7D illustrates a screen during the scan.

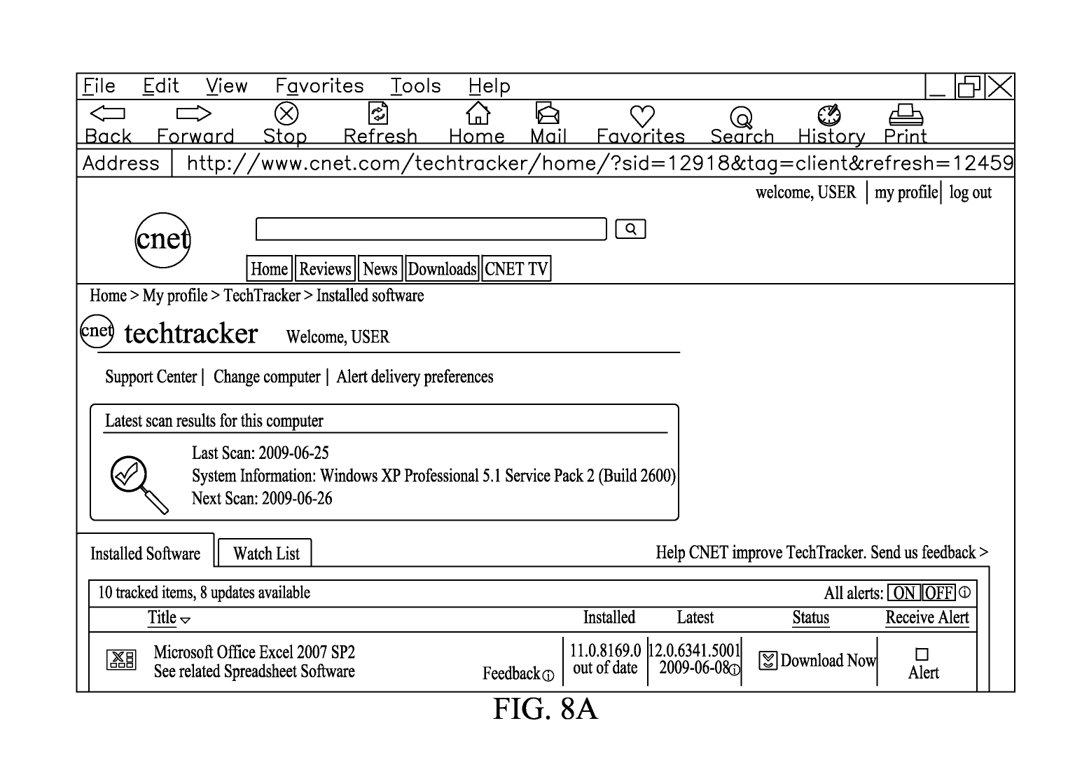

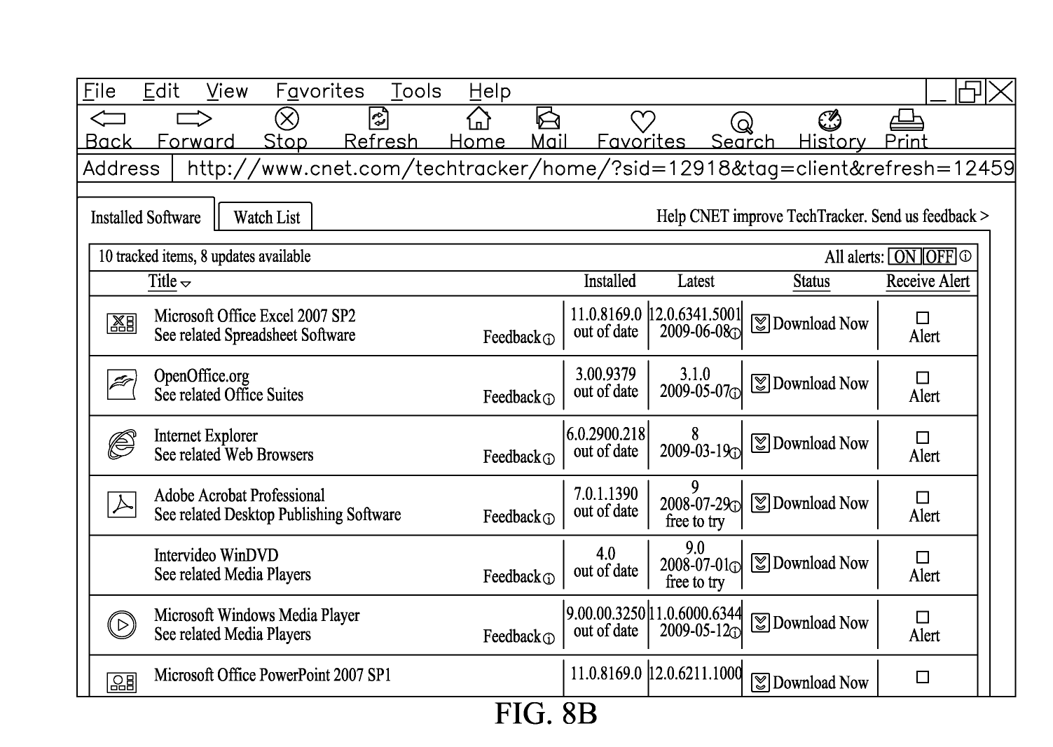

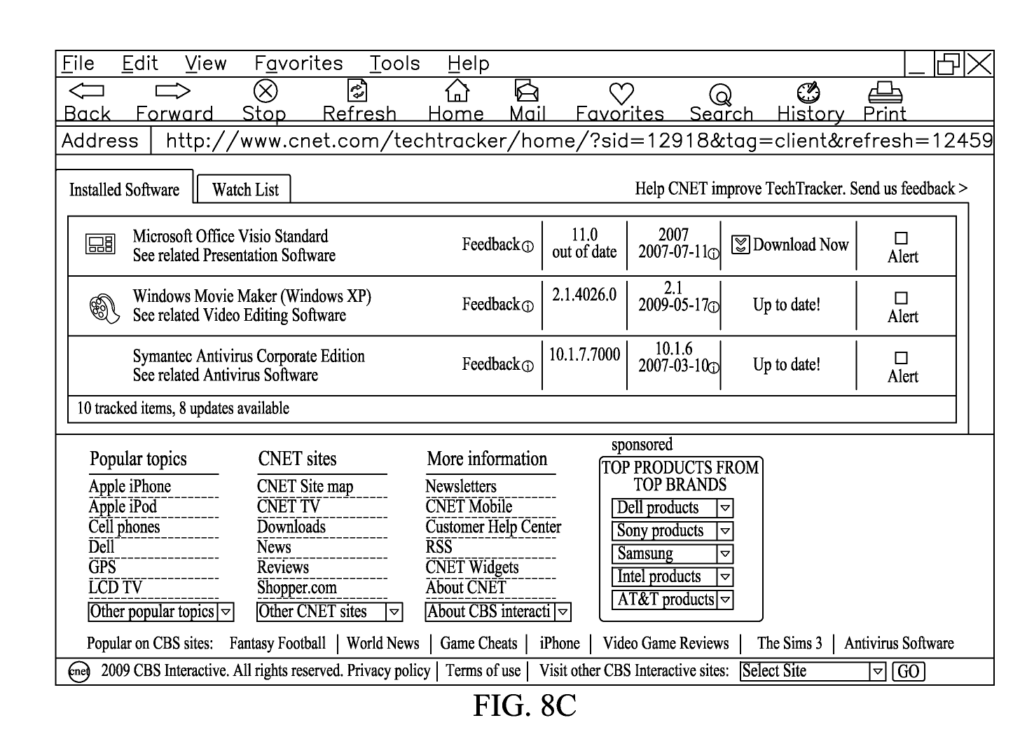

FIGS. 8A-8C illustrate exemplary user interfaces for accessing the tracking report. FIGS. 8A-8C illustrate a tracking report for a user computer. As shown in FIGS. 8A-8C several of the applications are out of date and new version are available for download now.

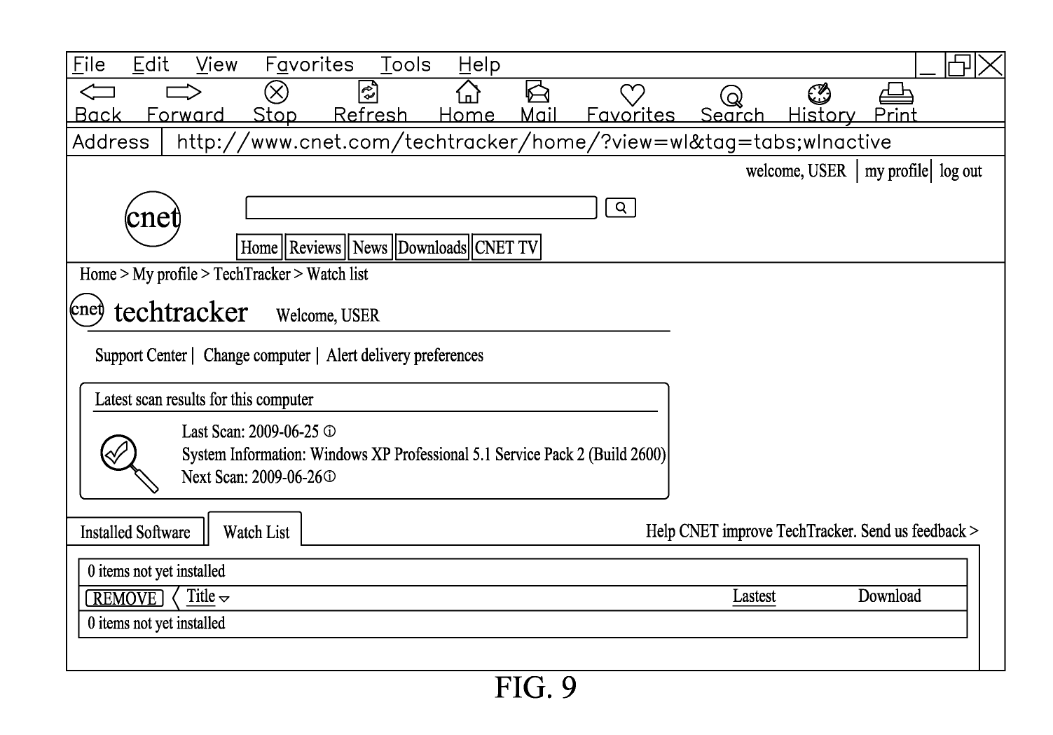

FIG. 9 illustrates an exemplary interface for setting up future scans. As shown in FIG. 9, users can generate a watch list. FIG. 9 also shows that the next scan is scheduled for the following day. Users are able to identify the time period for scans (daily, weekly, monthly, etc.).

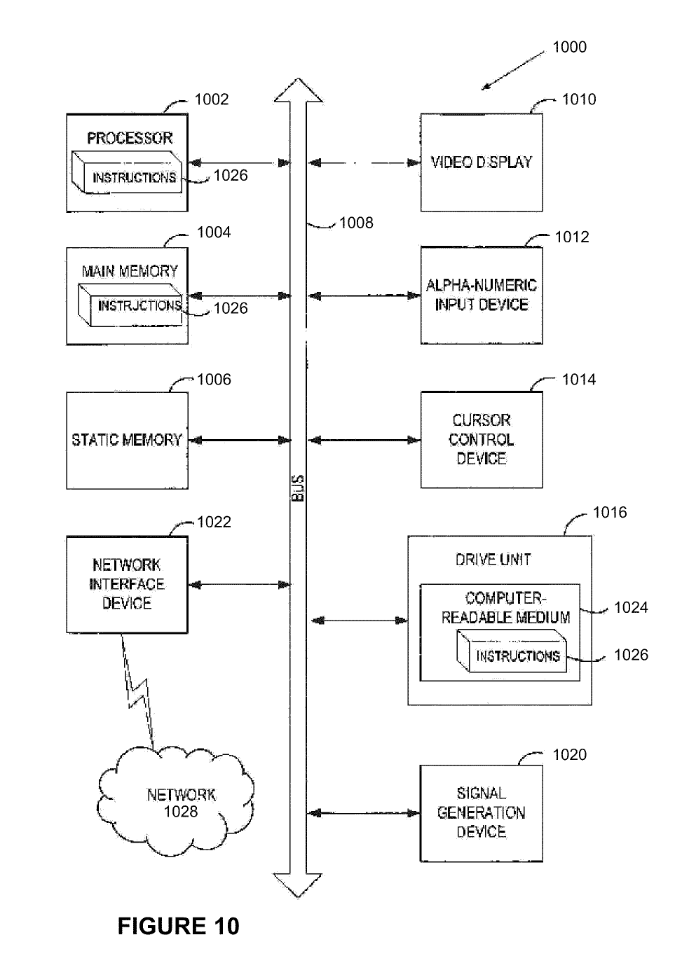

FIG. 10 shows a diagrammatic representation of machine in the exemplary form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processor 1002 (e.g., a central processing unit (CPU), a graphics processing unit (GPU) or both), a main memory 1004 (e.g., read only memory (ROM), flash memory, dynamic random access memory (DRAM) such as synchronous DRAM (SDRAM) or Rambus DRAM (RDRAM), etc.) and a static memory 1006 (e.g., flash memory, static random access memory (SRAM), etc.), which communicate with each other via a bus 1008.

The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1020 (e.g., a speaker) and a network interface device 1022.

The disk drive unit 1016 includes a computer-readable medium 1024 on which is stored one or more sets of instructions (e.g., software 1026) embodying any one or more of the methodologies or functions described herein. The software 1026 may also reside, completely or at least partially, within the main memory 1004 and/or within the processor 1002 during execution thereof by the computer system 1000, the main memory 1004 and the processor 1002 also constituting computer-readable media.

The software 1026 may further be transmitted or received over a network 1028 via the network interface device 1022.

While the computer-readable medium 1024 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, and optical and magnetic media.

It should be noted that the server is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method comprising:
receiving product data at an installed product application programming interface, the product data associated with a machine identifier;
receiving a user request to access a web application, the user request comprising the machine identifier and a user identifier;
associating the user identifier with the product data at the installed product application programming interface by matching the machine identifier at the installed product application programming interface with the machine identifier from the user request;
generating a web page that includes a tracking report using the product data; and
delivering the web page to the user.

2. The computer-implemented method of claim 1, wherein the product data comprises matching product data.

3. The computer-implemented method of claim 1, wherein the product data comprises scan data.

4. The computer-implemented method of claim 1, wherein the user identifier is associated with a plurality of machine identifiers.

5. The computer-implemented method of claim 4, further comprising matching the product data associated with each of the plurality of machine identifiers and allowing a user to download software so that each machine has the same installed software.

6. The computer-implemented method of claim 1, wherein the web page provides access to a catalogue.

7. The computer-implemented method of claim 1, wherein the product data comprises data about software applications installed on the user computer.

8. The computer-implemented method of claim 1, wherein the product data comprises data about data files stored on a user computer.

9. The computer-implemented method of claim 1, wherein the installed product application programming interface receives the product data periodically.

10. A computer-readable storage media having computer executable instructions stored thereon which cause a computer system to carry out a method when executed, the method comprising:
receiving product data at an installed product application programming interface, the product data associated with a machine identifier;
receiving a user request to access a web application, the user request comprising the machine identifier and a user identifier;
associating the user identifier with the product data at the installed product application programming interface by matching the machine identifier at the installed product application programming interface with the machine identifier in the user request;
generating a web page that includes a tracking report using the product data; and
delivering the web page to the user.

11. The computer-readable storage media of claim 10, wherein the product data comprises matching product data.

12. The computer-readable storage media of claim 10, wherein the product data comprises scan data.

13. The computer-readable storage media of claim 10, wherein the web page provides access to a catalogue.

14. The computer-readable storage media of claim 10, wherein the product data comprises data about software applications installed on the user computer.

15. A computer system comprising:
a processing module configured to receive a user request to access a web page, the user request comprising a user identifier and a machine identifier, the machine identifier associated with a user computer and the user identifier associated with a user of the user computer, the processing module further configured to deliver a web page to the user responsive to the user request; and
an installed program application programming interface in communication with the processing module and configured to receive a machine identifier and product data from the user computer, the installed program application programming interface further configured to receive the machine identifier and the user identifier from the processing module and associate the product data with the user identifier by matching the machine identifier from the processing module with the machine identifier stored at the installed program application programming interface.

16. The computer system of claim 15, further comprising memory coupled to the installed program application programming interface and configured to store the product data and the machine identifier.

17. The computer system of claim 15, wherein the user request is a cookie and wherein the processing module is configured to extract the user identifier and machine identifier from the cookie.

18. The computer system of claim 15, further comprising a catalogue in communication with the processing module, the processing module configured to allow users to access the catalogue.

19. The computer system of claim 15, further comprising a client adapter coupled to the web application, the client adapter configured to match scan data from a scan of the user computer to a copy of the catalogue stored to generate the product data received at the installed program application programming interface.

20. The computer system of claim 19, further comprising a client downloadable to the user computer and configured to be in communication with the computer system, the client configured to transmit scan data from a scan of the user computer to the client adapter.
